(19) United States
(12) Patent Application Publication
(10) Pub. No.: US 2014/0169595 A1
(43) Pub. Date: Jun. 19, 2014

(54) SOUND REPRODUCTION CONTROL APPARATUS

(71) Applicant: Kabushiki Kaisha Toshiba, Tokyo (JP)

(72) Inventors: Akihiko ENAMITO, Kanagawa-ken (JP); Osamu NISHIMURA, Kanagawa-ken (JP); Takahiro HIRUMA, Tokyo (JP)

(73) Assignee: KABUSHIKI KAISHA TOSHIBA, Tokyo (JP)

(21) Appl. No.: 13/973,767

(22) Filed: Aug. 22, 2013

(30) Foreign Application Priority Data
Sep. 26, 2012 (JP) P2012-213082

(51) Int. Cl. H04R 5/04

(52) U.S. Cl. CPC H04R 5/04
USPC 381/303

(57) ABSTRACT

A first loudspeaker group driven by a first sound reproduction signal, radiates a plurality of first sounds, and generates a first sound image synthesized from the plurality of first sounds. A second loudspeaker group driven by a second sound reproduction signal, radiates a plurality of second sounds, and generates a second sound image synthesized from the plurality of second sounds. The first and second sound reproduction signals are generated so that a first sound pressure ratio of a first control point to a second control point is equal to a second sound pressure ratio of the first control point to the second control point. The first sound pressure ratio is formed by a third sound radiated from a virtual sound source driven by a target sound reproduction signal. The second sound pressure ratio is formed by a third sound image synthesized from the first and second sound images.

### CROSS-REFERENCE TO RELATED APPLICATION

This application is based upon and claims the benefit of priority from Japanese Patent Application No. 2012-213082, filed on Sep. 26, 2012; the entire contents of which are incorporated herein by reference.

### FIELD

Embodiments described herein relate generally to a sound reproduction control apparatus.

### BACKGROUND

Conventionally, an apparatus for initiating an acoustic effect of 3-D (three-dimensional) sound reproduction signal (For example, 5.1 channel) by a front loudspeaker is well known. Hereinafter, this apparatus is called “sound reproduction control apparatus”. In the sound reproduction control apparatus, at a listener's position remotely apart from the front loudspeaker, distance attenuation occurs to a sound pressure of sound radiated from the front loudspeaker. By an influence of the distance attenuation of the sound pressure, in comparison with another listener's position near the front loudspeaker, at the listener's position remotely apart therefrom, a balance (such as amplitude ratio) of the sound pressure between both ears of the listener is largely lost. Briefly, the distance attenuation of sound pressure is undesirable for the listener to listen to 3-D sound reproduction by the sound reproduction control apparatus. In general, the sound attenuation of sound pressure can be reduced by using a line sound source (sound source having a wider width than a height). However, when this line sound source is used as the front loudspeaker in place of a regular loudspeaker, as to the sound reproduction control apparatus to initiate 3-D sound reproduction by using a plurality of loudspeakers, a size thereof becomes large.

### BRIEF DESCRIPTION OF THE DRAWINGS

FIG. 1 is a schematic diagram of the sound reproduction control apparatus according respective embodiments.

FIG. 2 is a block diagram of the sound reproduction control apparatus according to the first embodiment.

FIG. 3 is a schematic diagram to explain one example of a simulation result according to the first embodiment.

FIG. 4 is a block diagram of the sound reproduction control apparatus according to the second embodiment.

FIG. 5 is a schematic diagram to explain one example of position of both ears.

FIGS. 6A and 6B are schematic diagrams to explain one example of position of a virtual sound source.

FIGS. 7A and 7B are schematic diagrams to explain one example of calculation result of IACF (inter-aural cross correlation function).

FIGS. 8A and 8B are schematic diagrams to explain another example of calculation result of IACF (inter-aural cross correlation function).

### DETAILED DESCRIPTION

According to one embodiment, a sound reproduction control apparatus includes a first group of loudspeakers, a second group of loudspeakers, and a generation unit. The first group of loudspeakers driven by a first sound reproduction signal, radiates a plurality of first sounds, and generates a first sound image synthesized from the plurality of first sounds. The second group of loudspeakers driven by a second sound reproduction signal, radiates a plurality of second sounds, and generates a second sound image synthesized from the plurality of second sounds. The generation unit is configured to generate the first sound reproduction signal and the second sound reproduction signal so that a first sound pressure ratio of a first control point to a second control point apart from the first control point is equal to a second sound pressure ratio of the first control point to the second control point. The first sound pressure ratio is formed by a third sound radiated from a virtual sound source driven by a target sound reproduction signal. The second sound pressure ratio is formed by a third sound image synthesized from the first sound image and the second sound image.

Various embodiments will be described hereinafter with reference to the accompanying drawings.

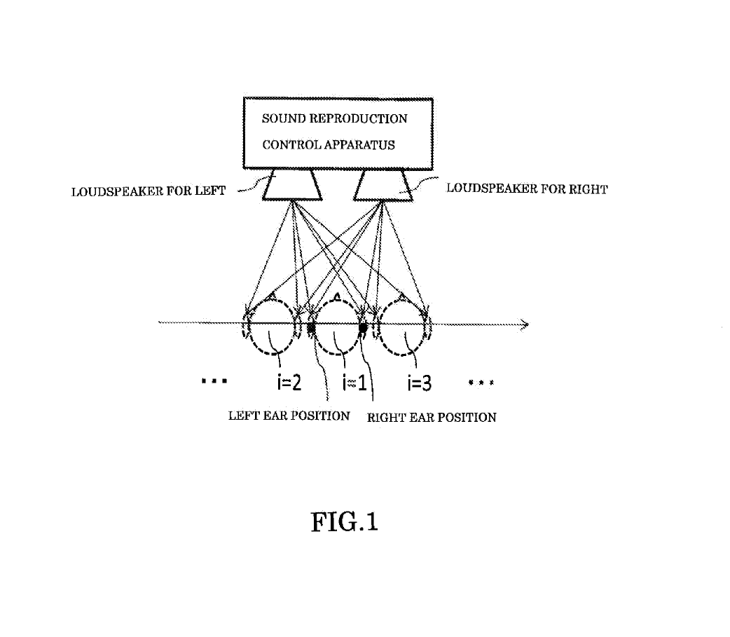

FIG. 1 is a schematic diagram to explain outline of the sound reproduction control apparatus according respective embodiments. In the sound reproduction apparatus explained hereafter, control filter processing is executed to a monaural sound reproduction signal or a binaural sound reproduction signal, and a sound is radiated from a front loudspeaker equipped with the sound reproduction apparatus. A listener listens to a sound (3-D sound reproduction) from the front loudspeaker at one or a plurality of listening position (i) in front of the front loudspeaker. Here, the 3-D sound reproduction is a sound imitating the monaural sound reproduction signal or the binaural sound reproduction signal heard from a virtual sound source position.

If a sound source actually exists at the virtual sound source position, between sound source reproduction signals arrived at the listener's both ears from the sound source, an amplitude ratio and a time difference (i.e., a phase difference) is occurred due to a difference between respective distances from the sound source to the listener's left ear and right ear. Based on the amplitude ratio and the time difference, the listener can perceive a sound source direction.

As a basic control policy common to respective embodiments, a complex sound pressure ratio at positions of the listener's both ears is approximated to a (arrival) complex sound pressure ratio of the sound production signal arrived from the virtual sound source (or a complex sound pressure ratio of the binaural sound reproduction signal). Here, as to a first control point for the left ear and a second control point for the right ear, the complex sound pressure ratio is calculated as a ratio of sound pressure of the second control point to sound pressure of the first control point. Moreover, as the positions of the listener's both ears (distance between the first control point and the second control point), for example, a distance between both ears of a regular person is used.

By this control policy, if the sound reproduction signal inputted is the monaural sound reproduction signal (=S), for example, as to reappearance of the sound reproduction signal arrived from the virtual sound source, detail of control filter processing is determined so as to satisfy a following equation (1).

$$\frac{{d}_{Ri} S}{{d}_{Li} S} = \frac{{d}_{Ri}}{{d}_{Li}} ≅ \frac{{P}_{Ri}}{{P}_{Li}} \qquad ( 1 )$$

Here, i (=1, 2, . . . ) represents an index to identify an imaginary position of both ears. A complex volume velocity of a loudspeaker for left and a loudspeaker for right is represented as q_{L} and q_{R} respectively. An arrival sound pressure (=P_{Li}, P_{Ri}) at position (i) of both ears is guided by a following equation (2).

P_{Li}=C_{Lil}·q_{L}+C_{LiR}·q_{R}

P_{Ri}=C_{RiL}·q_{L}+C_{RiR}·q_{R} (2)

In order to satisfy the equation (2), the control policy aims minimization of a sound reproduction energy (=Q) shown in a following equation (3). Here, N represents a total number of index (=i).

$$Q = {\sum }_{i = 1}^{N} ( Δ {P}_{i} \cdot Δ {P}_{i}^{*} ) -> min \\ Δ {P}_{i} = {d}_{Ri} \cdot {P}_{Li} - {d}_{Li} \cdot {P}_{Ri} \qquad ( 3 )$$

As shown in a following equation (4), the complex volume velocity (=q_{L}) is divided into a real number part (=q_{L}^{r}) and an imaginary number (=q_{L}ⁱ). As shown in a following equation (5), by partially differentiating the sound production energy (=Q) with the real number part (=q_{L}^{r}) and the imaginary number (=q_{L}ⁱ) a following equation (6) is guided. If the equation (6) is satisfied, the complex sound pressure ratio at position of the listener's both ears is equal to a complex sound pressure ratio of desired sound production signal.

$$\begin{matrix}{q}_{L} = {q}_{L}^{r} + j \cdot {q}_{L}^{i} & ( 4 ) \\ \frac{\partial Q}{\partial {q}_{L} r} = 0 , \\ \frac{\partial Q}{\partial {q}_{L} i} & ( 5 ) \\ ∴ {q}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {q}_{R} \\ ∵ {A}_{i} = {C}_{LiL} \cdot {d}_{Ri} - {C}_{RiL} \cdot {d}_{Li} \\ {B}_{i} = {C}_{LiR} \cdot {d}_{Ri} - {C}_{RiR} \cdot {d}_{Li} & ( 6 )\end{matrix}$$

Here, C_{LiL} represents a head-related transfer function from the loudspeaker for left to the listener's left ear (the first control point) at position (i) of both ears. C_{LiR} represents a head-related transfer function from the loudspeaker for right to the listener's left ear (the first control point) at position (i) of both ears. C_{RiL} represents a head-related transfer function from the loudspeaker for left to the listener's right ear (the second control point) at position (i) of both ears. C_{RiR} represents a head-related transfer function from the loudspeaker for right to the listener's right ear (the second control point) at position (i) of both ears. d_{Li} represents a head-related transfer function from the loudspeaker for virtual sound source to the listener's left ear (the first control point) at position (i) of both ears. d_{Ri} represents a head-related transfer function from the loudspeaker for virtual sound source to the listener's right ear (the second control point) at position (i) of both ears.

Here, the complex volume velocity (=q_{L}, q_{R}) is equivalent to the sound reproduction signal after the control filter processing is executed thereto. Accordingly, the control filter satisfying the equation (6) is guided by following equations (7) and (8).

$$( \begin{matrix}{P}_{L} \\ {P}_{R}\end{matrix} ) = ( \begin{matrix}{C}_{LL} & {C}_{LR} \\ {C}_{RL} & {C}_{RR}\end{matrix} ) ( \begin{matrix}{q}_{L} \\ {q}_{R}\end{matrix} ) \\ ( \begin{matrix}{q}_{L} \\ {q}_{R}\end{matrix} ) = ( \begin{matrix}{W}_{L} & 0 \\ 0 & {W}_{R}\end{matrix} ) ( \begin{matrix}S \\ S\end{matrix} ) \\ ∴ ( \begin{matrix}{P}_{L} \\ {P}_{R}\end{matrix} ) = ( \begin{matrix}{C}_{LL} & {C}_{LR} \\ {C}_{RL} & {C}_{RR}\end{matrix} ) ( \begin{matrix}{W}_{L} & 0 \\ 0 & {W}_{R}\end{matrix} ) ( \begin{matrix}S \\ S\end{matrix} ) \qquad ( 7 )$$

In the equation (7), a control filter coefficient (=W_{L}) for left and a control filter coefficient (=W_{R}) for right satisfy a following equation (8).

$$∴ {W}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {W}_{R} \\ ∵ {A}_{i} = {C}_{LiL} \cdot {d}_{Ri} - {C}_{RiL} \cdot {d}_{Li} \\ {B}_{i} = {C}_{LiR} \cdot {d}_{Ri} - {C}_{RiR} \cdot {d}_{Li} \qquad ( 8 )$$

Furthermore, if the sound reproduction signal inputted is the binaural sound reproduction signal (=S_{L}, S_{R}), by replacing d_{Li} and d_{Ri} in the equation (6) with “1”, a following equation (9) is guided. If the equation (9) is satisfied, the complex sound pressure ratio at position of the listener's both ears is equal to a complex sound pressure ratio of desired sound production signal.

$$∴ {q}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {q}_{R} \\ ∵ {A}_{i} = {C}_{LiL} - {C}_{RiL} \\ {B}_{i} = {C}_{LiR} - {C}_{RiR} \qquad ( 9 )$$

Accordingly, the control filter coefficient (=W_{L}) for left and the control filter coefficient (=W_{R}) for right satisfy a following equation (10).

$$∴ {W}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {W}_{R} \\ ∵ {A}_{i} = {C}_{LiL} - {C}_{RiL} \\ {B}_{i} = {C}_{LiR} - {C}_{RiR} \qquad ( 10 )$$

Moreover, in above explanation, based on the control filter coefficient (=W_{R}) for right, the control filter coefficient (=W_{L}) for right is guided. However, conversely, based on the control filter coefficient (=W_{L}) for left, the control filter coefficient (=W_{R}) for right may be guided. Anyway, based on one control filter coefficient, the other control filter coefficient is guided. Furthermore, the control filter as a basis may be arbitrary, for example, a through characteristic (i/e., “1”).

In the sound reproduction apparatus of respective embodiments explained hereafter, for example, even if a hearing position (a position of the listener's both ears) is set apart from the front loudspeaker, even if a plurality of hearing positions is set, or even if the position of the listener's both ears is changed when a direction of the listener's head is changed or when the listener's head is moved as a few decimeters, by reducing an effect of distance attenuation of the sound pressure, variation of the amplitude ratio and the time difference of the sound pressure arrived at both ears can be suppressed. As a result, 3-D sound reproduction to be intended can be heard by the listener.

### The First Embodiment

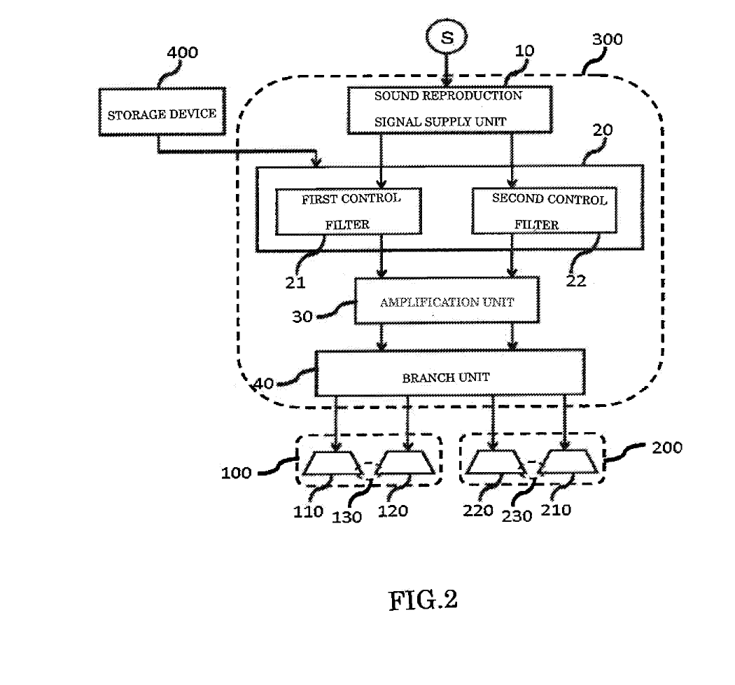

FIG. 2 is a block diagram of the sound reproduction control apparatus according to the first embodiment.

In the sound reproduction control apparatus of FIG. 2, loudspeakers 100 for left, loudspeakers 200 for right, an operation control device 300 such as a CPU, and a storage device 400 such as a memory, are equipped. The loudspeakers 100 and 200 are used as a front loudspeaker.

The loudspeakers 100 for left include a first loudspeaker 110 and a second loudspeaker 120 adjacently located. The loudspeakers 200 for right include a third loudspeaker 210 and a fourth loudspeaker 220 adjacently located. In the first embodiment, by simultaneously driving with a sound reproduction signal having same amplitude and same phase, the first loudspeaker 110 and the second loudspeaker 120 radiate a sound respectively. Briefly, the first loudspeaker 110 and the second loudspeaker 120 function as a radiation form of line sound source to form a first sound image 130. Furthermore, by simultaneously driving with a sound reproduction signal having same amplitude and same phase, the third loudspeaker 210 and the fourth loudspeaker 220 radiate a sound respectively. Briefly, the third loudspeaker 210 and the fourth loudspeaker 220 function as a radiation form of line sound source to form a second sound image 230. The first sound image 130 is a sound reproduction signal radiated from a virtual sound source as if the first loudspeaker 110 and the second loudspeaker 120 are regarded as one loudspeaker (For example, a center part between the first loudspeaker 110 and the second loudspeaker 120). Furthermore, the second sound image 230 is a sound reproduction signal radiated from a virtual sound source as if the third loudspeaker 210 and the fourth loudspeaker 220 are regarded as one loudspeaker (For example, a center part between the third loudspeaker 210 and the fourth loudspeaker 220).

The operation processing device 300 includes a sound reproduction signal supply unit 10, a control filter (generation) unit 20, an amplification unit 30, and a branch unit 40. The sound reproduction signal supply unit 10 supplies a monaural sound reproduction signal to the control filter 20. The control filter 20 executes control filter processing to the monaural signal. The amplification unit 30 amplifies a signal received from the control filter 20. The branch unit 40 branches the amplified signal, and supplies to respective loudspeakers.

The storage device 400 stores a head-related transfer function (C_{LiL}, C_{RiL}) from the loudspeakers 100 for left to a listener (the left ear and the right ear) locating at the position (i) of both ears, and a head-related transfer function (C_{LiR}, C_{RiR}) from the loudspeakers 200 for right to a listener (the first control point and the second control point) locating at the position (i) of both ears. Furthermore, the storage device 400 stores a head-related transfer function (d_{Li}, d_{Ri}) from a position of the virtual sound source to a listener (the first control point and the second control point) locating at the position (i) of both ears.

In the first embodiment, specifically, as the head-related transfer function (C_{LiL}, C_{RiL}) the storage device 400 stores a head-related transfer function represented as a following equation.

C_{LiL}=C_{LiL1}+C_{LiL2}

C_{RiL}=C_{RiL1}+C_{RiL2} (11)

Here, C_{LiL1} represents a head-related transfer function from the first loudspeaker 110 to the listener's left ear (the first control point) locating at the position (i) of both ears. C_{LiL2} represents a head-related transfer function from the second loudspeaker 120 to the listener's left ear (the first control point) locating at the position (i) of both ears. C_{RiL1} represents a head-related transfer function from the first loudspeaker 110 to the listener's right ear (the second control point) locating at the position (i) of both ears. C_{RiL2} represents a head-related transfer function from the second loudspeaker 120 to the listener's right ear (the second control point) locating at the position (i) of both ears.

Furthermore, as the head-related transfer function (C_{LiR}, C_{RiR}), the storage device 400 stores a head-related transfer function represented as a following equation.

C_{LiR}=C_{LiR1}+C_{LiR2}

C_{RiR}=C_{RiR1}+C_{RiR2} (12)

Here, C_{LiR1} represents a head-related transfer function from the third loudspeaker 210 to the listener's left ear (the first control point) locating at the position (i) of both ears. C_{LiR2} represents a head-related transfer function from the fourth loudspeaker 220 to the listener's left ear (the first control point) locating at the position (i) of both ears. C_{RiR1} represents a head-related transfer function from the third loudspeaker 210 to the listener's right ear (the second control point) locating at the position (i) of both ears. C_{RiR2} represents a head-related transfer function from the fourth loudspeaker 220 to the listener's right ear (the second control point) locating at the position (i) of both ears.

The sound reproduction signal supply unit 10 acquires a monaural sound reproduction signal (=S) (target sound reproduction signal) from the outside, and supplies the monaural sound reproduction signal to the control filter 20. As a method for the sound reproduction signal supply unit 10 to acquire the monaural sound reproduction signal (=S), various variations can be applied. For example, such as a television, an audio equipment or an AV equipment, contents including a sound reproduction signal (For example, contents including the sound reproduction signal only, contents including the sound reproduction signal with moving images or static images, contents including another relational information therewith) (Hereinafter, they are called “contents”) may be acquired by terrestrial broadcasting or satellite broadcasting. The contents may be acquired via an Internet, an Intranet, or a home network. Furthermore, the contents may be obtained by reading from a storage medium such as a CD, a DVD, or a stored disk device. Furthermore, a voice inputted via a microphone may be acquired. The sound reproduction signal supply unit 10 supplies the monaural sound reproduction signal (=S) (acquired in this way) to the control filter 20.

The control filter 20 includes a first control filter for left and a second control filter for right. Here, a control filter coefficient (=W_{R}) of the second control filter 22 is previously determined. If the number of position of both ears is one, the control filter 20 generates a sound reproduction signal radiated from the first loudspeaker 110 and the second loudspeaker 120, and generates a sound reproduction signal radiated from the third loudspeaker 210 and the fourth loudspeaker 220. Here, respective sound reproduction signals are generated so that a complex sound pressure ratio (second sound pressure ratio) formed by a third sound image (synthesized from a first sound image and a second sound image) at the position of both ears is equal (or approximated) to a complex sound pressure ratio (first sound pressure ratio) of a sound reproduction signal coming from the virtual sound source to the position of both ears.

If the number of position of both ears is at least two, respective sound reproduction signals are generated so that a spatial average of complex sound pressure ratios at positions of both ears is equal (or approximated) to a spatial average of complex sound pressure ratios of the sound reproduction signal coming from the virtual sound source to the positions of both ears. Here, the spatial location of complex sound pressure ratio is, for example, as shown in a following equation (13), a ratio of a total of square of a complex amplitude function at respective positions of both ears (at specific timing). The complex amplitude function is represented by a head-related transfer function (=C) from respective loudspeakers to a left ear (the first control point) and a right ear (the second control point) of both ears, and a head-related transfer function (=d) from the virtual sound source to the left ear (the first control point) and the right ear (the second control point) of both ears. Moreover, the total includes a weighted sum. By convoluting the monaural sound reproduction signal (=S) with the control filter coefficient (represented by the equation (13)), a spatial averaging of the complex sound pressure ratio at positions of both ears can be realized.

The first control filter 21 reads following head-related transfer functions from the storage device 400. Specifically, a head-related transfer function (=C_{LiL}) from the loudspeakers 100 for left to a listener's left ear (the first control point) at positions (i=1, . . . , N) of both ears, a head-related transfer function (=C_{RiL}) from the loudspeakers 100 for left to the listener's right ear (the second control point) at positions (i=1, . . . , N) of both ears, a head-related transfer function (=C_{LiR}) from the loudspeakers 200 for right to the listener's left ear (the first control point) at positions (i=1, . . . , N) of both ears, a head-related transfer function (=C_{RiR}) from the loudspeakers 200 for right to the listener's right ear (the second control point) at positions (i=1, . . . N) of both ears, a head-related transfer function (=d_{Li}) from the virtual sound source to the listener's left ear (the first control point) at positions (i=1, . . . , N) of both ears, a head-related transfer function (=d_{Ri}) from the virtual sound source to the listener's right ear (the second control point) at positions (i=1, . . . , N) of both ears, are read out.

Based on the head-related transfer function (read from the storage device 400) and the control filter coefficient (=W_{R}) of the second control filter 22, the first control filter 21 calculates a control filter coefficient (=W_{L}) so as to satisfy the equation (13). Moreover, calculation of the control filter coefficient (=W_{L}) may be calculated by not the control filter 21 but a calculator (not shown in FIG. 2). Alternatively, by previously calculating the control filter coefficient (=W_{R}) of the second control filter 22 and the control filter coefficient (=W_{L}) corresponding to combination of the virtual sound source and the position of both ears, the second control filter 21 may suitably the control filter coefficient (=W_{L}).

$${W}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {W}_{R} = - \frac{{\sum }_{i = 1}^{N} ( {B}_{i} \cdot {A}_{i}^{*} )}{{\sum }_{i = 1}^{N} {\vert {A}_{i} \vert}^{2}} {W}_{R} \\ ∵ {A}_{i} = {C}_{LiL} \cdot {d}_{Ri} - {C}_{RiL} \cdot {d}_{Li} \\ {B}_{i} = {C}_{LiR} \cdot {d}_{Ri} - {C}_{RiR} \cdot {d}_{Li} \qquad ( 13 )$$

The first control filter 21 convolutes the control filter coefficient (=W_{L}) with (executes an FIR operation to) the monaural sound reproduction signal (S) from the sound reproduction signal supply unit 10, and generates a second sound reproduction signal (=W_{L}S) for left. The first control filter 21 supplies the second sound reproduction signal to an amplification unit 30. The second control filter 22 convolutes the control filter coefficient (=W_{R}) with (executes the FIR operation to) the monaural sound reproduction signal (S) from the sound reproduction signal supply unit 10, and generates a third sound reproduction signal (=W_{R}S) for right. The second control filter 22 supplies the third sound reproduction signal to the amplification unit 30.

The amplification unit 30 amplifies the second sound reproduction signal (=W_{L}S) from the first control filter 21 and the third sound reproduction signal (=W_{R}S) from the second control filter 22, and supplies the amplified signal to a branch unit 40.

The branch unit 40 accepts the second sound reproduction signal and the third sound reproduction signal (each amplified) from the amplification unit 30. The branch unit 40 branches the second sound reproduction signal, and supplies the branched signal to the first loudspeaker 110 and the second loudspeaker 120 of the loudspeakers 100 for left. Furthermore, the branch unit 40 branches the third sound reproduction signal, and supplies the branched signal to the third loudspeaker 210 and the fourth loudspeaker 220 of the loudspeakers 200 for right.

In the loudspeakers 100 for left, the first loudspeaker 110 and the second loudspeaker 120 accept the second sound reproduction signal amplified from the branch unit 400, and simultaneously radiate the second sound reproduction signals having the same amplitude and the same phase. Furthermore, in the loudspeakers 200 for right, the third loudspeaker 210 and the fourth loudspeaker 220 accept the third sound reproduction signal amplified from the branch unit 400, and simultaneously radiate the third sound reproduction signals having the same amplitude and the same phase. Here, radiation of the sound reproduction signal means, the loudspeaker is driven by the sound reproduction signal, and the sound reproduction signal is radiated as a sound wave. Here, “simultaneously” means, for example, respective timings to input the second sound reproduction signal to the first loudspeaker 110 and the second loudspeaker 120 are equal, or respective timings to input the third sound reproduction signal to the third loudspeaker 210 and the second loudspeaker 220 are equal.

When the sound reproduction signal supply unit 10 accepts the binaural signal (=S_{L}, S_{R}) (the first target sound reproduction signal, the second target sound reproduction signal), and supplies the binaural signal to the control filter 20, if the number of positions of both ears is one, the control filter 20 equalizes (or approximates) a complex sound pressure ratio at the position of both ears to a complex sound pressure ratio of the binaural sound reproduction signal (i.e., a sound pressure ratio of S_{R} to S_{L}). If the number of positions of both ears is at least two, the control filter 20 equalizes (or approximates) a spatial average of the complex sound pressure ratio at the positions of both ears to the complex sound pressure ratio of the binaural sound reproduction signal.

Briefly, based on the head-related transfer function (read from the storage device 400) and the control filter coefficient (=W_{R}) of the second control filter 22, the first control filter 21 calculates the control filter coefficient (=W_{L}) so as to satisfy a following equation (14).

$${W}_{L} = - \frac{{\sum }_{i = 1}^{N} ( {B}_{i} \cdot {A}_{i}^{*} )}{{\sum }_{i = 1}^{N} ( {A}_{i} \cdot {A}_{i}^{*} )} {W}_{R} = - \frac{{\sum }_{i = 1}^{N} ( {B}_{i} \cdot {A}_{i}^{*} )}{{\sum }_{i = 1}^{N} {\vert {A}_{i} \vert}^{2}} {W}_{R} \\ ∵ {A}_{i} = {C}_{LiL} - {C}_{RiL} \\ {B}_{i} = {C}_{LiR} - {C}_{RiR} \qquad ( 14 )$$

Furthermore, in above-mentioned explanation, in order to simplify, one virtual sound source is used. However, a plurality of virtual sound sources may be used. In this case, the control filter 20 calculates a control filter (W_{Lj}, W_{Rj}) corresponding to respective virtual sound sources j. By using the control filter (W_{Lj}, W_{Rj}) and the sound reproduction signal (Sⱼ) corresponding to respective virtual sound sources j, the control filter 20 calculates the second sound reproduction signal (=ΣⱼW_{Lj}Sⱼ) and the third sound reproduction signal (=ΣⱼW_{Rj}Sⱼ).

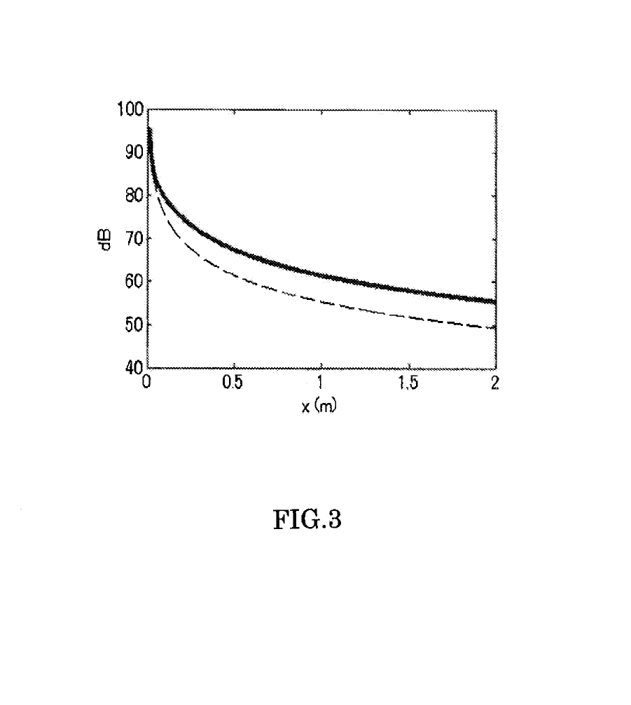

FIG. 3 shows a simulation result that a distance attenuation of sound source when two loudspeakers are simultaneously driven is compared with a distance attenuation of sound source when one loudspeaker is driven. Moreover, in both cases, a distance from respective loudspeakers is 2 meter. As a result, in comparison with the case of one loudspeaker, the distance attenuation of sound pressure in the case of two loudspeakers is more reduced.

According to the sound reproduction control apparatus of the first embodiment, the loudspeakers 100 for left and the loudspeakers 200 for right radiate sound reproduction signals by a radiation form of line sound source. Accordingly, the distance attenuation of sound source can be reduced. As a result, 3-d sound reproduction to be intended can be heard by a listener without losing a balance of sound source between both ears of the listener. Furthermore, in this case, as the first loudspeaker 110 and the second loudspeaker 120 (included in the loudspeakers 100 for left) and the third loudspeaker 210 and the fourth loudspeaker 220 (included in the loudspeakers 200 for right), a regular loudspeaker of which height and width are approximately equal is used. Accordingly, in comparison with the case of using a line sound source (For example, a line array loudspeaker), a size of the sound reproduction control apparatus can be smaller.

### The Second Embodiment

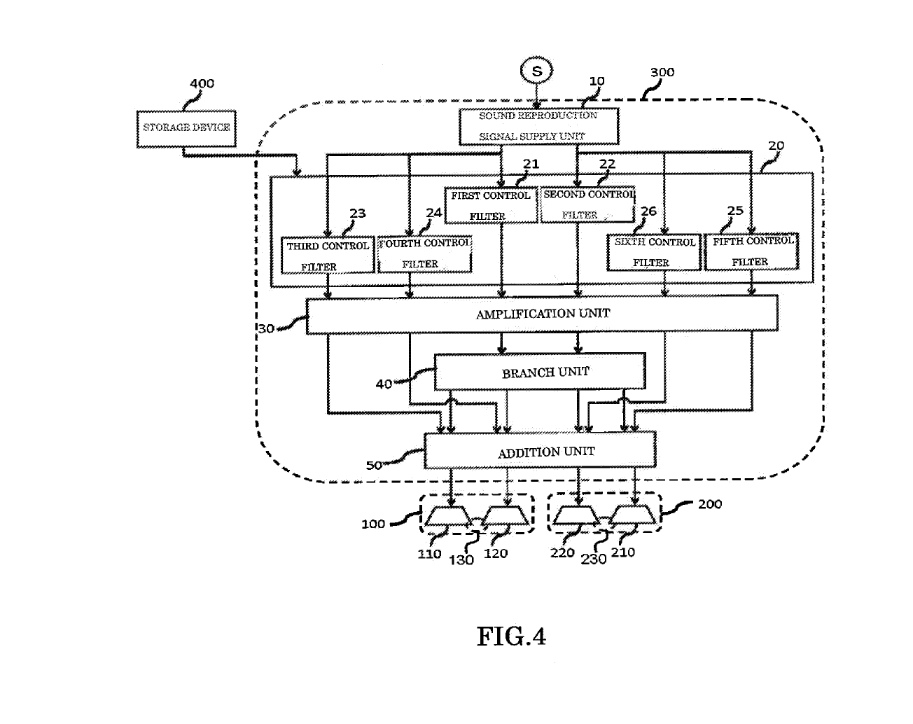

FIG. 4 is a block diagram of the sound reproduction apparatus according to the second embodiment. Moreover, as to the same block as the sound reproduction control apparatus of FIG. 2, the same sign is assigned, and the detail explanation thereof is omitted.

In the second embodiment, the first loudspeaker 110 and the second loudspeaker 120 function as a radiation form of line sound source by simultaneously radiating the sound reproduction signal having the same amplitude and the same phase. Furthermore, the first loudspeaker 110 and the second loudspeaker 120 function as a radiation form of point sound source by respectively radiating the sound reproduction signal. In the same way, the third loudspeaker 210 and the fourth loudspeaker 220 function as a radiation form of line sound source by simultaneously radiating the sound reproduction signal having the same amplitude and the same phase. Furthermore, the third loudspeaker 210 and the fourth loudspeaker 220 function as a radiation form of point sound source by respectively radiating the sound reproduction signal. Briefly, the loudspeakers 100 for left and the loudspeakers 200 for right radiate the sound reproduction signal by overlapping radiation forms of line sound source and point sound source.

In the sound reproduction apparatus of FIG. 4, the control filter 20 further includes a third control filter 23, a fourth control filter 24, a fifth control filter 25, and a sixth control filter 26.

Hereinafter, as to the third control filter 23, the fourth control filter 24, the fifth control filter 25 and the sixth control filter 26, method for calculating a set of respective control filter coefficients (=W′_{L}, W_{S}, W_{T}, W′_{R}) thereof is explained. Here, a control filter coefficient (=W′_{R}) of the sixth control filter 26 may be a through characteristic. In following explanation, as a rule, assume that “W_{R}=1”. First, the above-mentioned equation (2) is replaced with a following equation (15).

P_{Li}=C_{LiL1}·q_{L}+C_{LiR1}·q_{R}+C_{LiL2}·q_{S}+C_{LiR2}·q_{T}

P_{Ri}=C_{RiL1}·q_{L}+C_{RiR1}·q_{R}+C_{RiL2}·q_{S}+C_{RiR2}·q_{T} (15)

In the equation (15), q_{L}, q_{S}, q_{T} and q_{R} respectively represent a complex volume velocity of loudspeakers 110, 120, 220 and 210. By referring to the equation (15) and above-mentioned explanation, following equations (16)˜(20) are guided.

$$\begin{matrix}{W}_{R}^{′} = 1 \\ {W}_{L}^{′} = - \frac{{\sum }_{i = 1}^{N} ( {P}_{i} \cdot {O}_{i}^{*} )}{{\sum }_{i = 1}^{N} ( {O}_{i} \cdot {O}_{i}^{*} )} {W}_{R}^{′} \\ {W}_{S} = - \frac{L \cdot {W}_{L}^{′} + M \cdot {W}_{R}^{′}}{N} \\ {W}_{T} - \frac{E \cdot {W}_{L}^{′} + F \cdot {W}_{S} + G \cdot {W}_{R}^{′}}{H} & ( 16 ) \\ {A}_{i} = {C}_{RiL 1} \cdot {d}_{Li} - {C}_{LiL 1} \cdot {d}_{Ri} \\ {B}_{i} = {C}_{RiL 2} \cdot {d}_{Li} - {C}_{LiL 2} \cdot {d}_{Ri} \\ {C}_{i} = {C}_{RiR 2} \cdot {d}_{Li} - {C}_{LiR 2} \cdot {d}_{Ri} \\ {D}_{i} = {C}_{RiR 1} \cdot {d}_{Li} - {C}_{LiR 1} \cdot {d}_{Ri} \\ i = 1 , 2 , … , N & ( 17 ) \\ E = {\sum }_{i = 1}^{N} ( {A}_{i} \cdot {C}_{i}^{*} ) \\ F = {\sum }_{i = 1}^{N} ( {B}_{i} \cdot {C}_{i}^{*} ) \\ G = {\sum }_{i = 1}^{N} ( {D}_{i} \cdot {C}_{i}^{*} ) \\ H = {\sum }_{i = 1}^{N} ( {C}_{i} \cdot {C}_{i}^{*} ) & ( 18 ) \\ {I}_{i} = {A}_{i} - \frac{{C}_{i} \cdot E}{{H}_{j}} \\ {J}_{i} = {B}_{i} - \frac{{C}_{i} \cdot F}{H} \\ {K}_{i} = {D}_{i} - \frac{{C}_{i} \cdot G}{H} \\ i = 1 , 2 , … , N & ( 19 ) \\ L = {\sum }_{i = 1}^{N} ( {I}_{i} \cdot {J}_{i}^{*} ) \\ M = {\sum }_{i = 1}^{N} ( {K}_{i} \cdot {J}_{i}^{*} ) \\ N = {\sum }_{i = 1}^{N} ( {J}_{i} \cdot {J}_{i}^{*} ) \\ {O}_{i} = {I}_{i} - \frac{{J}_{i} \cdot L}{N} \\ {P}_{i} = {K}_{i} - \frac{{J}_{i} \cdot M}{N} \\ i = 1 , 2 , … , N & ( 20 )\end{matrix}$$

In addition to head-related transfer functions (C_{LiL}, C_{RiL}) represented by the equation (11) and head-related transfer functions (C_{LiR}, C_{RiR}) represented by the equation (12), the storage device 400 in FIG. 4 stores a head-related transfer function C_{LiL1} from the first loudspeaker 110 to the listener's left ear (the first control point) at position (i) of both ears, a head-related transfer function C_{LiL2} from the second loudspeaker 120 to the listener's left ear (the first control point) at position (i) of both ears, a head-related transfer function C_{RiL1} from the first loudspeaker 110 to the listener's right ear (the second control point) at position (i) of both ears, a head-related transfer function C_{RiL2} from the second loudspeaker 120 to the listener's right ear (the second control point) at position (i) of both ears, a head-related transfer function C_{LiR1} from the third loudspeaker 210 to the listener's left ear (the first control point) at position (i) of both ears, a head-related transfer function C_{LiR2} from the fourth loudspeaker 220 to the listener's left ear (the first control point) at position (i) of both ears, a head-related transfer function C_{RiR1} from the third loudspeaker 210 to the listener's right ear (the second control point) at position (i) of both ears, and a head-related transfer function C_{RiR2} from the fourth loudspeaker 220 to the listener's right ear (the second control point) at position (i) of both ears.

Based on the head-related transfer functions (read from the storage device 400) and the control filter coefficient (=W′_{R}) of the sixth control filter 26, the third control filter 23, the fourth control filter 24 and the fifth control filter 25 calculate control filter coefficients (=W′_{L}, W_{S}, W_{T}) so as to satisfy above-mentioned equations (16)-(20).

The third control filter 23 convolutes the control filter coefficient (=W′_{L}) with (executes the FIR operation to) the monaural sound reproduction signal (S) from the sound reproduction signal supply unit 10, and generates a fourth sound reproduction signal (=W′_{L}S) for the first loudspeaker 110. The third control filter 23 supplies the fourth sound reproduction signal to the amplification unit 30. The fourth control filter 24 convolutes the control filter coefficient (=W_{S}) with (executes the FIR operation to) the monaural sound reproduction signal (S) from the sound reproduction signal supply unit 10, and generates a fifth sound reproduction signal (=W_{S}S) for the second loudspeaker 120. The fourth control filter 24 supplies the fifth sound reproduction signal to the amplification unit 30. The fifth control filter 25 convolutes the control filter coefficient (=W_{T}) with (executes the FIR operation to) the monaural sound reproduction signal (S) from the sound reproduction signal supply unit 10, and generates a sixth sound reproduction signal (=W_{T}S) for the third loudspeaker 220. The fifth control filter 25 supplies the sixth sound reproduction signal to the amplification unit 30. The sixth control filter 26 convolutes the control filter coefficient (=W′_{R}) with (executes the FIR operation to) the monaural sound reproduction signal (S) from the sound reproduction signal supply unit 10, and generates a seventh sound reproduction signal (=W′_{R}S) for the fourth loudspeaker 220. The sixth control filter 26 supplies the seventh sound reproduction signal to the amplification unit 30.

In addition to the second sound reproduction signal (=W_{L}S) from the first control filter 21 and the third sound reproduction signal (=W_{R}S) from the second control filter 22, the amplification unit 30 amplifies the fourth sound reproduction signal (=W′_{L}S) from the third control filter 23, the fifth sound reproduction signal (=W_{S}S) from the fourth control filter 24, the sixth sound reproduction signal (=W_{T}S) from the fifth control filter 25, and the seventh sound reproduction signal (=W′_{R}S) from the sixth control filter 26. The amplification unit 30 supplies respective amplification signals to an addition unit 50.

The addition unit 50 adds the second sound reproduction signal (amplified) to the fourth sound reproduction signal (amplified), and generates an eighth sound reproduction signal (=W_{L}S+W′_{L}S). The addition unit 50 supplies the eighth sound reproduction signal to the first loudspeaker 110. Furthermore, the addition unit 50 adds the second sound reproduction signal (amplified) to the fifth sound reproduction signal (amplified), and generates a ninth sound reproduction signal (=W_{L}S+W_{R}S). The addition unit 50 supplies the ninth sound reproduction signal to the second loudspeaker 110. The addition unit 50 adds the third sound reproduction signal (amplified) to the sixth sound reproduction signal (amplified), and generates a tenth sound reproduction signal (=W_{R}S+W_{T}S). The addition unit 50 supplies the tenth sound reproduction signal to the third loudspeaker 210. The addition unit 50 adds the third sound reproduction signal (amplified) to the seventh sound reproduction signal (amplified), and generates an eleventh sound reproduction signal (=W_{R}S+W′_{R}S). The addition unit 50 supplies the eleventh sound reproduction signal to the fourth loudspeaker 220.

The first loudspeaker 110 and the second loudspeaker 120 (in the loudspeakers 100 for left) accept the eighth sound reproduction signal and the ninth sound reproduction signal from the addition unit 50, and radiate them respectively. Furthermore, the third loudspeaker 210 and the fourth loudspeaker 220 (in the loudspeakers 200 for right) accept the tenth sound reproduction signal and the eleventh sound reproduction signal from the addition unit 50, and radiate them respectively.

Moreover, after amplifying the eighth sound reproduction signal, the ninth sound reproduction signal, the tenth sound reproduction signal and the eleventh sound reproduction signal (accepted from the addition unit 50), the amplification unit 30 may supply them to respective loudspeakers.

According to the control policy of the second embodiment, at positions of both ears of which the number is {(the number of loudspeakers)−1}, the complex sound pressure ratio can be equal to a target ratio. Furthermore, according to this policy, in addition to the positions of both ears of which the number is {(the number of loudspeakers)−1}, at a space between respective positions of both ears, the complex sound pressure ratio approximated to the target ratio can be expected.

As to above-mentioned sound reproduction control apparatus, the loudspeakers 100 for left and the loudspeakers 200 for right radiate the sound reproduction signal by overlapping radiation forms of two patterns (point/line sound source). Accordingly, even if the number of loudspeakers is not increased, the number of positions of both ears to equalize the complex sound pressure ratio to the target ratio can be increased. Furthermore, the loudspeakers 100 for left and the loudspeakers 200 for right radiate the sound reproduction signal by the radiation form of line sound source. Accordingly, effect of distance attenuation of sound pressure can be reduced. As a result, 3-D sound reproduction to be intended can be heard by the listener.

Moreover, in the sound reproduction control apparatus according to the first and second embodiments, the loudspeakers 100 for left and loudspeakers 200 for right may equip at least three loudspeakers respectively. If the number of loudspeakers equipped with the loudspeakers (100 or 200) is X, as to combination of two loudspeakers, the control filter coefficient is calculated for all combinations of {X (X−1)/2} kinds. Respective loudspeakers radiate the sound reproduction signal by overlapping a plurality of sound reproduction signals calculated based on these control filter coefficients.

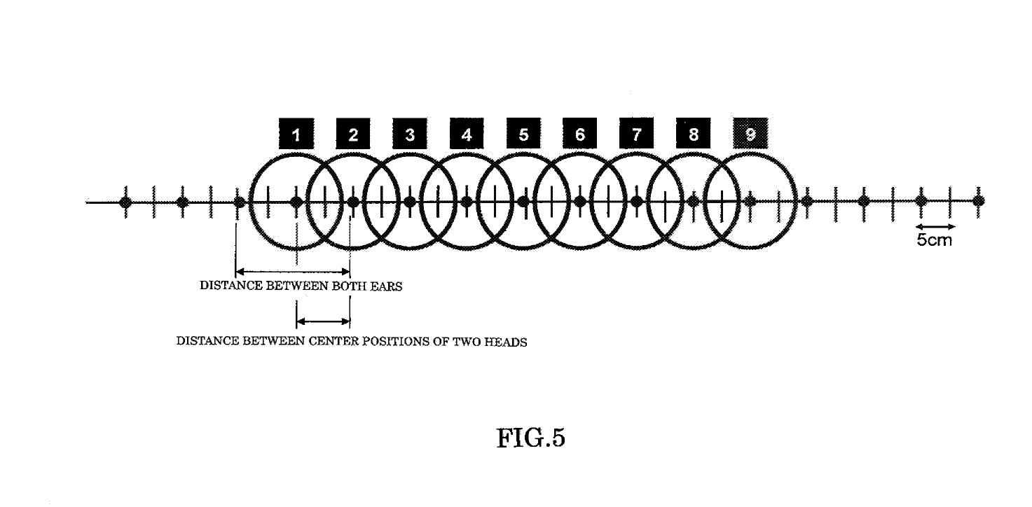

By referring to FIGS. 5˜8, the sound reproduction signal subjected to the control filter processing by using the sound reproduction control apparatus of the embodiment, is evaluated.

FIG. 5 is a schematic diagram to explain an evaluation condition of the sound reproduction signal. As shown in FIG. 5, in this example, the number of hearing positions (position of both ears) is nine (i=1, 2, 3, 4, 5, 6, 7, 8, 9), and respective loudspeakers has 6 channel. Furthermore, a distance between both ears is 20 cm, and a distance between ear positions of two listeners, i.e., a distance between center positions of two heads, is 10 cm.

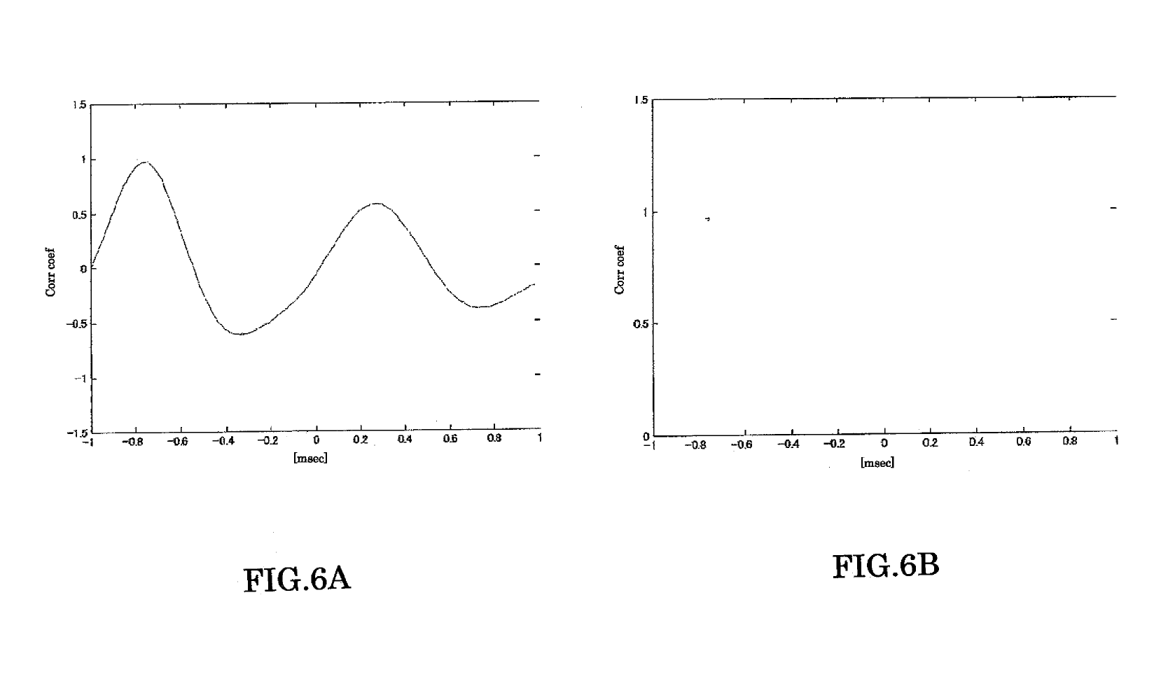

FIG. 6A shows an arrival sound pressure radiated from a predetermined virtual sound image position (target position) to a hearing position (position of both ears). FIG. 6B shows IACF (inter-aural cross correlation function) calculated based on the arrival sound pressure. In this example, a virtual sound source is located at the right just beside the hearing position (position of both ears), and the sound is radiated from this virtual sound source.

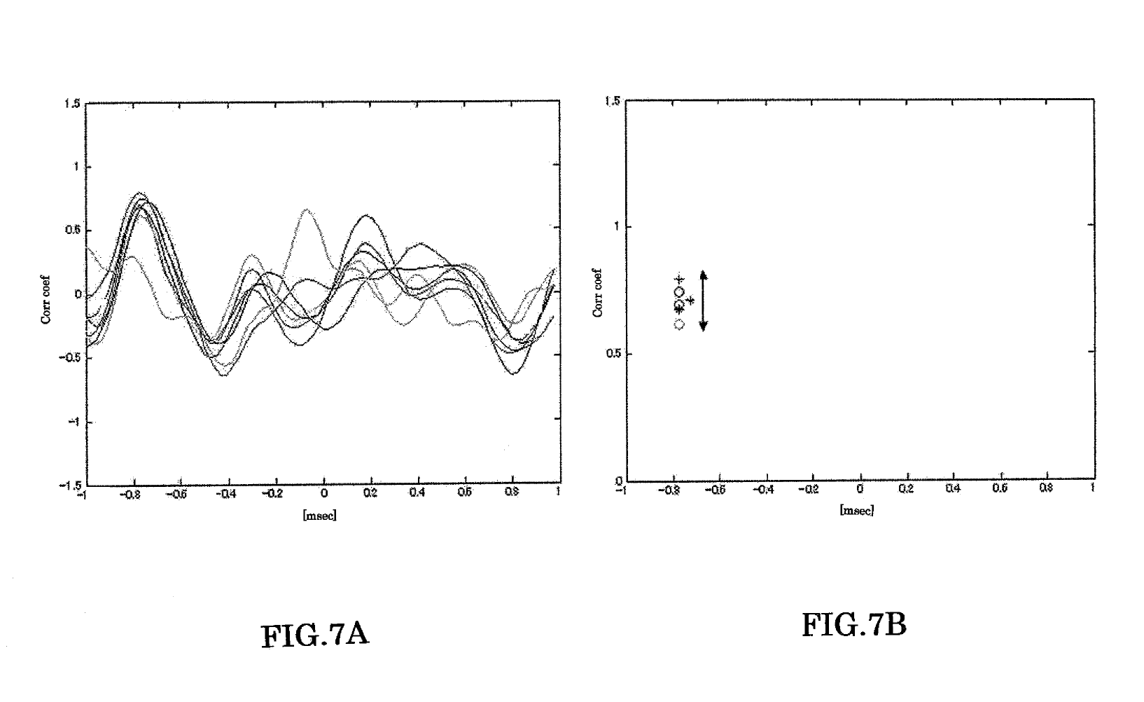

FIGS. 7A and 7B show IACF of the sound reproduction signal subjected to control filter processing by using the sound reproduction control apparatus of a comparison example. Briefly, by targeting the arrival sound pressure from the virtual sound source shown in FIG. 6, six loudspeakers respectively radiate a sound reproduction signal (function as only radiation form of point sound source). In this case, an example of IACF is shown in FIG. 7B.

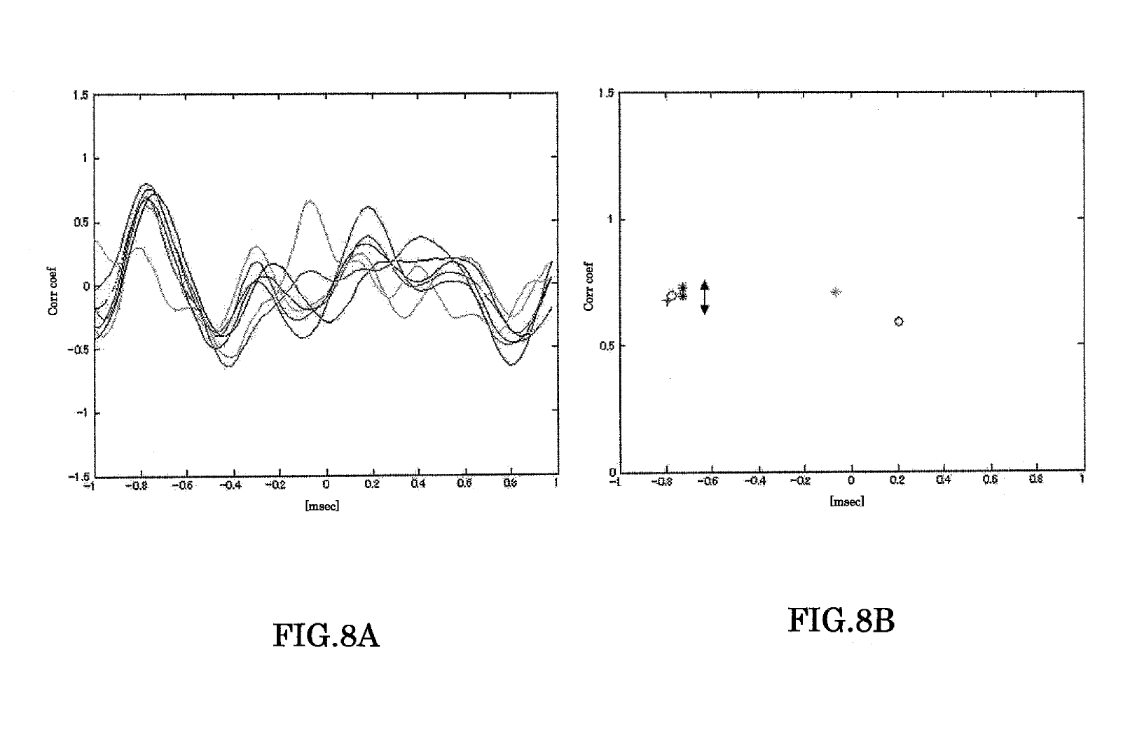

FIGS. 8A and 8B show IACF of the sound reproduction signal subjected to control filter processing by using the sound reproduction control apparatus of the embodiment. By targeting the arrival sound pressure from the virtual sound source shown in FIG. 6, six loudspeakers respectively radiate a sound reproduction signal (function as a radiation form of point sound source). Furthermore, two loudspeakers simultaneously radiate the sound reproduction signal having the same amplitude and the same phase (function as a radiation form of line sound source). In this case, an example of IACF is shown in FIG. 8B.

In the result shown in FIG. 7B, at a plurality of hearing positions (positions of both ears), a timing to occur a maximum peak of IACF is nearly equal to a timing to occur a peak of the arrival sound pressure. Accordingly, by using at least control policy common to the first and second embodiments, robustness for variation of the hearing position (position of both ears) is improved, and the hearing area is enlarged. However, the maximum peak of IACF is dispersed along the vertical axis direction.

On the other hand, in the result shown in FIG. 8B, at a plurality of hearing positions (positions of both ears), a timing to occur a maximum peak of IACF is nearly equal to a timing to occur a peak of the arrival sound pressure. In addition to this, in comparison with the result of FIG. 7B, dispersion of the maximum peak of IACF along the vertical axis direction is converged.

The head-related transfer function from a loudspeaker to a hearing position (position of both ears) reduces with increase of a distance between the loudspeaker to the hearing position, due to an effect of distance attenuation. Accordingly, if the head-related transfer function from a loudspeaker to a hearing position far from the loudspeaker is included in a head-related transfer function to spatially average the complex amplitude ratio, the control filter coefficients are dispersed. As a result, as shown in FIG. 7B, the maximum peak of IACF is dispersed along the vertical axis direction.

So, as shown in FIG. 8B, by functioning the loudspeaker as a radiation form of line sound source, reduction of the head-related transfer function at the hearing position (position of both ears) far from the loudspeaker can be suppressed. As a result, dispersion of the maximum peak of IACF along the vertical direction axis is converged. This dispersion of the maximum peak of IACF along the vertical direction axis influences auditory localization of 3-D sound reproduction. Briefly, in the sound reproduction control apparatus of the embodiment, the dispersion of the maximum peak of IACF along the vertical direction axis can be converged. Accordingly, auditory localization of 3-D sound reproduction can be improved.

As explained above, according to the sound reproduction control apparatus of at least one of the first and second embodiments, the distance attenuation of the sound pressure can be reduced without enlarging a size of the sound reproduction control apparatus.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound reproduction control apparatus comprising:
a first group of loudspeakers driven by a first sound reproduction signal, radiating a plurality of first sounds, and generating a first sound image synthesized from the plurality of first sounds;
a second group of loudspeakers driven by a second sound reproduction signal, radiating a plurality of second sounds, and generating a second sound image synthesized from the plurality of second sounds; and
a generation unit configured to generate the first sound reproduction signal and the second sound reproduction signal so that a first sound pressure ratio of a first control point to a second control point apart from the first control point is equal to a second sound pressure ratio of the first control point to the second control point;
wherein
the first sound pressure ratio is formed by a third sound radiated from a virtual sound source driven by a target sound reproduction signal, and
the second sound pressure ratio is formed by a third sound image synthesized from the first sound image and the second sound image.

2. The apparatus according to claim 1, wherein
the number of pairs of the first control point and the second control point is at least two, and
the generation unit generates the first sound reproduction signal and the second sound reproduction signal so that a spatial average of the first sound pressure ratio is equal to a spatial average of the second sound pressure ratio.

3. The apparatus according to claim 1, wherein
the first group of loudspeakers includes a first loudspeaker and a second loudspeaker,
the second group of loudspeakers includes a third loudspeaker and a fourth loudspeaker, and
the generation unit calculates a first control filter coefficient and a second control filter coefficient based on
a sum of
a first head-related transfer function from the first loudspeaker to the first control point and the second control point and
a second head-related transfer function from the second loudspeaker to the first control point and the second control point, and
a sum of
a third head-related transfer function from the third loudspeaker to the first control point and the second control point and
a fourth head-related transfer function from the fourth loudspeaker to the first control point and the second control point,
further comprising:
a first control filter configured to generate the first sound reproduction signal by convoluting the first control filter coefficient with the target sound reproduction signal; and
a second control filter configured to generate the second sound reproduction signal by convoluting the second control filter coefficient with the target sound reproduction signal.

4. The apparatus according to claim 3, wherein
one of the first control filter coefficient and the second control filter coefficient is a through characteristic filter.

5. A sound reproduction control apparatus comprising:
a first group of loudspeakers driven by a first sound reproduction signal, radiating a plurality of first sounds, and generating a first sound image synthesized from the plurality of first sounds;
a second group of loudspeakers driven by a second sound reproduction signal, radiating a plurality of second sounds, and generating a second sound image synthesized from the plurality of second sounds; and
a generation unit configured to generate the first sound reproduction signal and the second sound reproduction signal so that a first sound pressure ratio of a first target sound reproduction signal to a second target sound reproduction signal is equal to a second sound pressure ratio of a first control point to a second control point apart from the first control point;
wherein
an amplitude and a phase of the first target sound reproduction signal are different from an amplitude and a phase of the second target sound reproduction signal respectively, and
the second sound pressure ratio is formed by a third sound image synthesized from the first sound image and the second sound image.

6. The apparatus according to claim 5, wherein
the number of pairs of the first control point and the second control point is at least two, and
the generation unit generates the first sound reproduction signal and the second sound reproduction signal so that a spatial average of the first sound pressure ratio is equal to a spatial average of the second sound pressure ratio.

7. The apparatus according to claim 5, wherein
the first group of loudspeakers includes a first loudspeaker and a second loudspeaker,
the second group of loudspeakers includes a third loudspeaker and a fourth loudspeaker, and
the generation unit calculates a first control filter coefficient and a second control filter coefficient based on
a sum of
a first head-related transfer function from the first loudspeaker to the first control point and the second control point and
a second head-related transfer function from the second loudspeaker to the first control point and the second control point, and
a sum of
a third head-related transfer function from the third loudspeaker to the first control point and the second control point and
a fourth head-related transfer function from the fourth loudspeaker to the first control point and the second control point,
further comprising:
a first control filter configured to generate the first sound reproduction signal by convoluting the first control filter coefficient with the third sound reproduction signal; and
a second control filter configured to generate the second sound reproduction signal by convoluting the second control filter coefficient with the fourth sound reproduction signal.

8. The apparatus according to claim 7, wherein
one of the first control filter coefficient and the second control filter coefficient is a through characteristic filter.
